(19) United States
(12) Patent Application Publication
(10) Pub. No.: US 2006/0031068 A1
(43) Pub. Date: Feb. 9, 2006

(54) Analysis method

(75) Inventors: Ju-Ying Wang, Yuanlin Town (TW); Bao-Jen Yan, Hsinchu City (TW); Ting-Wei Chen, Zhonghe City (TW)

Correspondence Address: BIRCH STEWART KOLASCH & BIRCH, PO BOX 747, FALLS CHURCH, VA, 22040-0747, US

(73) Assignee: Powerchip Semiconductor Corp.

(21) Appl. No.: 11/113,247

(22) Filed: Apr. 25, 2005

(30) Foreign Application Priority Data
Aug. 9, 2004 (TW) 93123777

(51) Int. Cl. G10L 15/08

(52) U.S. Cl. 704/238

(57) ABSTRACT

An analysis method is disclosed. At least one layer is disposed on a substrate, covering a pre-analysis pattern and a reference pattern. A portion of the layer is removed to expose the reference pattern, and locate the unexposed pre-analysis pattern, using the reference pattern as a reference. Thus, the pre-analysis pattern is capable to be analyzed precisely without damage.

### BACKGROUND

The invention relates to failure analysis method, and in particular to a failure analysis method for semiconductor devices.

With development of semiconductor manufacturing technology, device size has been reduced to increase gross die. Critical dimensions of semiconductor devices are currently less 0.11 μm. Consequently, precise cross-section analysis of patterns in semiconductor devices increases in difficulty.

In conventional technology, patterns covered with metal layer, such as W, can not be verified by top view. A conventional method for failure analysis of semiconductor devices includes trial and error, increasing both time consumption and inaccuracy.

An alternative method removes entire layers from a pre-analysis pattern and analyzes the pattern thereof, but damage is likely to be caused during processing.

### SUMMARY

An embodiment of the invention provides an analysis method, comprising providing a substrate comprising a pre-analysis pattern and a reference pattern covered by at least one layer. A portion of the least one layer is removed to expose the reference pattern. The unexposed pre-analysis pattern is located using the exposed reference pattern, and the located pre-analysis pattern is subsequently analyzed.

### BRIEF DESCRIPTION OF THE DRAWINGS

The invention can be more fully understood by reading the subsequent detailed description and examples with references made to the accompanying drawings, wherein:

FIGS. 1A-1B are sectional views of a method for analyzing a semiconductor device.

FIGS. 2A-2C are top views of a method for analyzing a semiconductor device.

FIG. 3A shows an etching method of an embodiment of the invention;

FIG. 3B shows another etching method of an embodiment of the invention;

FIG. 4A shows a misalignment of a TEM sample.

FIG. 4B shows a TEM picture during misalignment.

FIG. 5A shows a TEM sample aligned precisely to a TEM scribe line.

FIG. 5B shows a TEM picture with no misalignment.

FIG. 6 is a flowchart of an analysis method of an embodiment of the invention.

### DETAILED DESCRIPTION OF THE INVENTION

### FIRST EMBODIMENT

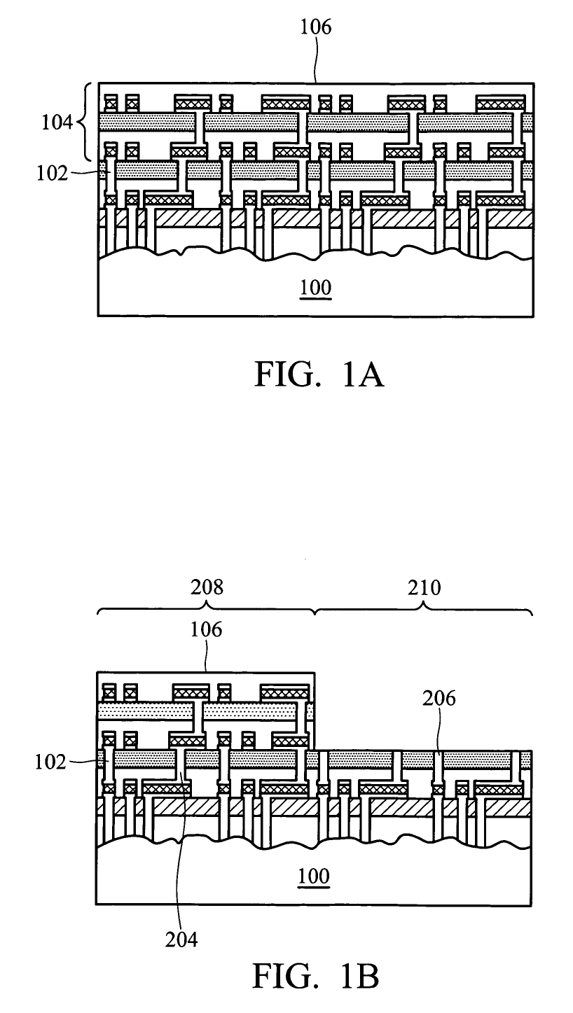

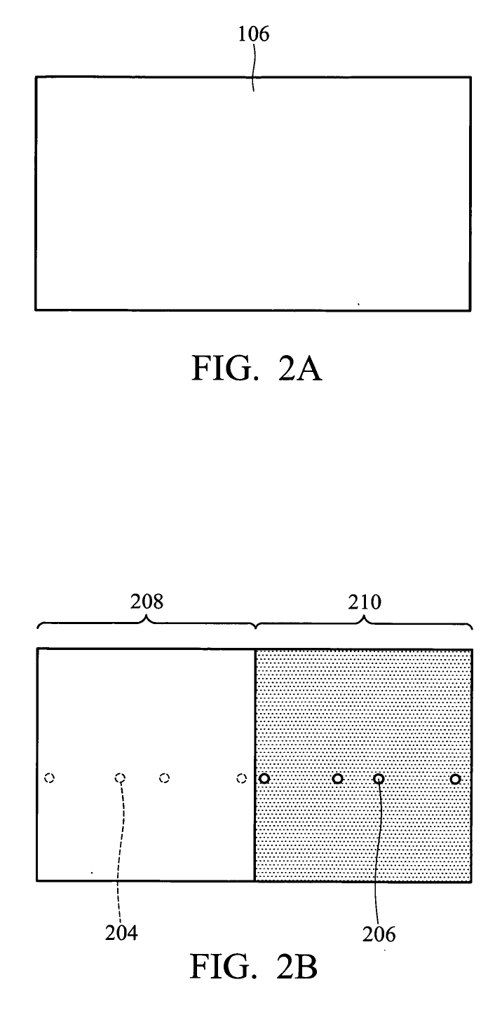

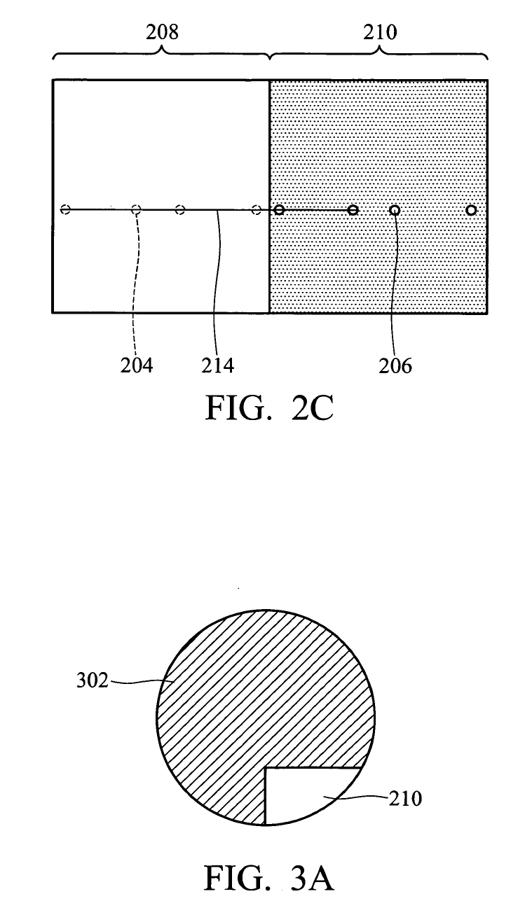

FIGS. 1A-1B are sectional views of a method for analyzing a semiconductor device. FIGS. 2A-2C are top views of a method for analyzing a semiconductor device. In FIG. 1A and FIG. 2A, wherein FIG. 2A is a top view of FIG. 1A, a substrate 100 is provided. In an embodiment, the substrate 100 may comprise a plurality of layers 104, semiconductor devices or thin film transistors formed thereon or therein. The substrate 100 may comprise semiconductor substrate, such as silicon substrate, as used in IC manufacturing technology, glass substrate or resin substrate. The layers 104 described may be any film, such as metal film, dielectric film or semiconductor film, and any forming method, such as CVD, PVD and oxidation, is acceptable. The devices described may be any device or pattern, formed by any conventional technology, such as deposition, etching, ion implantation or combinations thereof. As shown in FIG. 2A, the substrate is covered by a plurality of layers, such that patterns in the layers or in the substrate cannot be located by viewing of a top surface 106.

In the embodiment, the patterns in the layers or substrate are regular, continuous or regular and continuous, but not limited to the disclosure in the embodiment. For example, the patterns may be regularly arranged contact holes of interconnect structure of semiconductor device. The contact holes may be arranged along an axis, and present regular distance. In FIG. 1A, a pre-analysis pattern 208 is required to enact failure analysis. In the embodiment, the pre-analysis pattern 208 comprises contact holes, but is not limited thereto. For example, a contact hole 102 between layers in a semiconductor device is difficult to analyze from the top surface 106 due to layers 104, such as tungsten layer, aluminum layer, silicon oxide layer or silicon nitride layer thereon.

In FIG. 2B, a pre-analysis layer includes a pre-analysis pattern 204 and a reference pattern 206. The pre-analysis pattern 204 is disposed in the pre-analysis region 208, and the reference pattern 206 disposed beyond the pre-analysis region 208. In the embodiment, the pre-analysis pattern 204 and the reference pattern 206 are disposed in the same layer, but are not limited thereto. The pre-analysis pattern 204 and the reference pattern 206 may not be in the same layer.

Next, a portion of layers over a pre-removing region 210 beyond the pre-analysis region 208 is removed to expose the reference pattern 206 in the pre-analysis layer. In the embodiment, as shown in FIG. 1B and FIG. 2B, the reference pattern 204 may be regular arranged contact holes, arranged in an axis, presenting regular distance therebetween. Location and shape of the pre-analysis pattern 204 in the pre-analysis region cannot be verified from the top view for coverage of layers 104 thereon.

In the embodiment, removal of a portion of the layers over the pre-removing region 210 may be accomplished by Focused Ion Bean (FIB). Ion beam with Ar or Ga as ion source is used in the FIB method. The ion beam may present more power and mass than electronics. A series of impact and energy transformations may be generated on a target surface when irradiated by the ion beam, and the target surface is oxidized and ionized to sputter neutral atoms, ions, electrons and electromagnetic waves. Note that the crystals in irradiated regions may be damaged by the ion beam, as atoms are mixed. Layer removal may be accomplished by the chrematistics described.

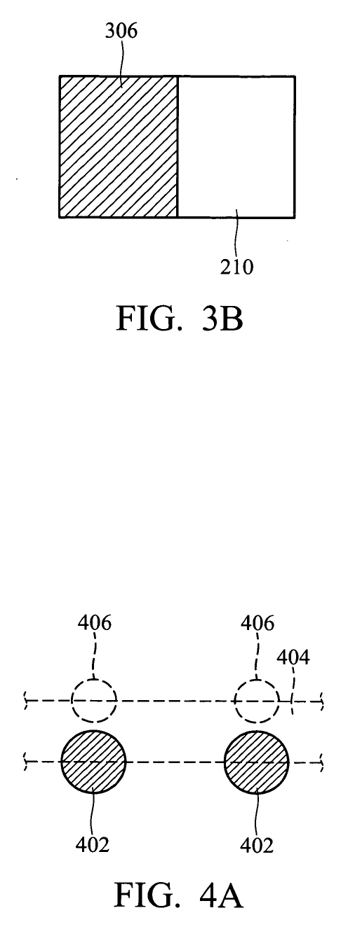

Additionally, removal of layers may also be accomplished by mask definition and subsequent etching. As shown in FIG. 3A, remove of layers with large area may be accomplished by the following method. A sawed second substrate 302, such as a wafer, is used as a mask to cover the area requiring protection, exposing the pre-removal region 210. In FIG. 3B, polymer may also be used as the mask 306, drawn with marker, such as oil pen. The substrate 100 is subsequently placed in an etching apparatus to remove the layers exposed, after which etching parameters may be tuned.

Furthermore, remove of a portion of the layers over the pre-removing region 210 may be accomplished by chemical mechanical polishing method with a tilt polishing plate or a dimple polishing. Additionally, layer removal may also be accomplished by laser injection, in which the layers over the pre-removing region 210 are irradiated by high power laser beams. While methods described is disclosed, the disclosure is not limited thereto.

The unexposed pre-analysis pattern 204 can be located by reference with the exposed reference pattern 206. For example, in FIG. 2C, the reference pattern 204 and the pre-analysis pattern 206 are contact holes, arranged along a line 214 extending to the pre-analysis region 208. The position of the pre-analysis pattern 204 is located according to line 214 and regularity of space between contact holes. Next, the pre-analysis pattern 204 is analyzed and inspected according to the located position.

### SECOND EMBODIMENT

The method of the second embodiment is similar to the first embodiment, with the only difference being that the pre-analysis pattern and the exposed reference pattern are non-regular. The pre-analysis pattern is not easily located according to the exposed reference pattern. In the embodiment, the pre-analysis pattern is located according to the exposed reference pattern using a CAD layout comprising the pre-analysis pattern and the reference pattern as a reference. The reference pattern can be compared with the CAD layout to determine the position of the pre-analysis pattern.

During preparation of a Transmission Electron Microscope, TEM sample, the methods described in the first and second embodiment can locate the pre-analysis pattern when covered by layers. The layers over the reference pattern are removed, using the reference pattern as a reference to locate the pre-analysis pattern.

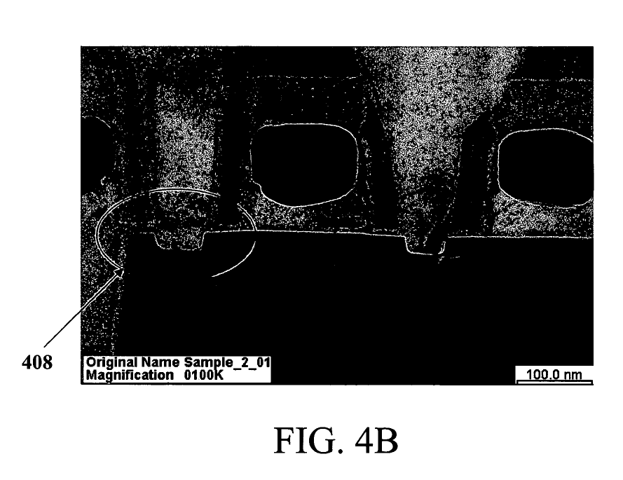

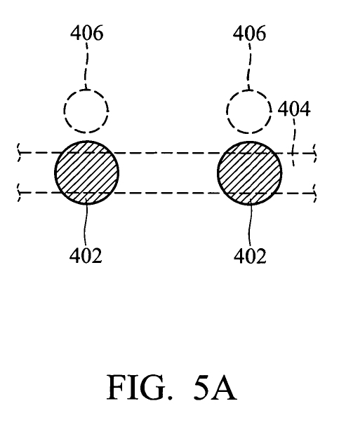

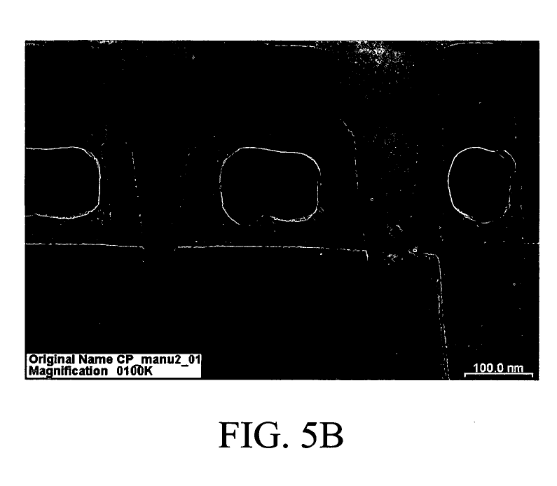

FIG. 4A shows misalignment of a TEM sample. FIG. 4B shows a TEM picture during misalignment. As shown in FIGS. 4A and 4B, overlay shadow 408 is generated if contact holes 402 are not aligned with a TEM scribe line, in which additional structures 406 are included when preparing a TEM sample 404. FIG. 5A shows a TEM sample aligned precisely with a TEM scribe line. FIG. 5B shows a TEM picture with no misalignment. As shown in FIG. 5A, the TEM sample 404 can be aligned to the TEM scribe line precisely by using the method described, with no overlay shadow is not generated since the TEM sample does not overlap additional structure 406, as shown in FIG. 5B.

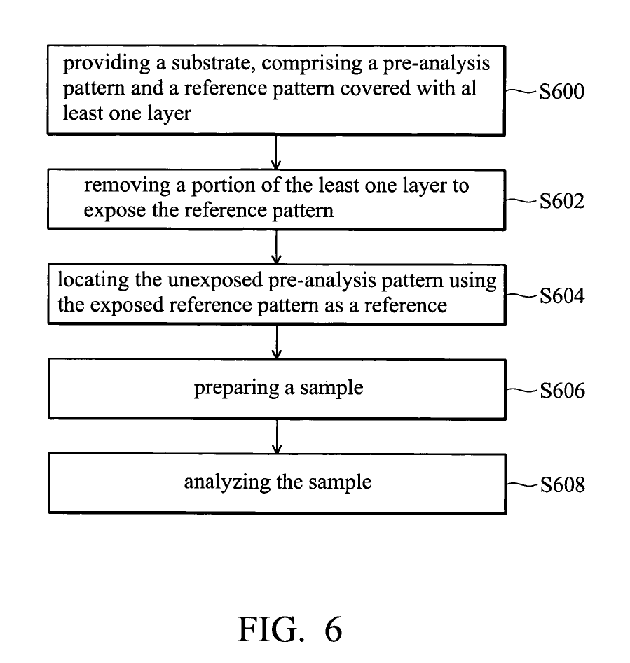

FIG. 6 is a flowchart of an analysis method of an embodiment of the invention. First, a substrate comprising a pre-analysis pattern and a reference pattern with at least one layer formed thereon is provided in step S600. A portion of the layer is removed to expose the reference pattern in step S602. The unexposed pre-analysis pattern is located using the reference pattern as a reference S604. An analysis sample is prepared S606. The prepared sample is analyzed S608. The analysis can be used in any process, such as semiconductor process or liquid crystal display process. Scanning Electron Microscope (SEM), Transmission Electron Microscope (TEM), Scanning Transmission Electron Microscope (STEM) or Focused Ion Beam (FIB) can be used to analyze the sample. Energy dispersive X-ray spectrometry (EDX), electron energy loss spectrometry (EELS) or Auger can further analyze the surface characteristics, material or element of the sample.

Accordingly, the analysis method and analysis sample of the invention is fast and precise, and pattern damage may be eliminated. Further, overlay shadow due to misalignment during preparation of the analysis sample may also be diminished.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An analysis method, comprising:
providing a substrate, comprising a pre-analysis pattern and a reference pattern covered with at least one layer;
removing a portion of the least one layer to expose the reference pattern;
locating the unexposed pre-analysis pattern using the exposed reference pattern as a reference; and
analyzing the located pre-analysis pattern.

2. The method as claimed in claim 1, wherein the pre-analysis pattern and the reference pattern are regular and continuous.

3. The method as claimed in claim 1, wherein the pre-analysis pattern and the reference pattern comprise a plurality of contact holes arranged regularly and continuously.

4. The method as claimed in claim 3, wherein the contact holes are disposed in a line.

5. The method as claimed in claim 1, wherein removal of a portion of the least one layer is accomplished by Focused Ion Bean.

6. The method as claimed in claim 1, wherein removal of a portion of the least one layer is accomplished by chemical mechanical polishing with tilt polishing plate.

7. The method as claimed in claim 1, wherein removal of a portion of the least one layer is accomplished by a dimple polishing method.

8. The method as claimed in claim 1, wherein removal of a portion of the least one layer is accomplished by etching.

9. The method as claimed in claim 8, wherein the etching method comprises covering the pre-analysis region using a polymer layer as a mask.

10. The method as claimed in claim 8, wherein the etching method comprises covering the pre-analysis region using a sawed substrate as a mask.

11. The method as claimed in claim 1, wherein removal of a portion of the least one layer is accomplished by laser irradiation.

12. The method as claimed in claim 1, wherein the pre-analysis pattern and the reference pattern are non-regular.

13. The method as claimed in claim 12, wherein location of the unexposed pre-analysis pattern comprises comparing a CAD layout including the pre-analysis pattern and the reference pattern with the reference pattern to locate the reference pattern.

14. The method as claimed in claim 1, wherein analysis of the located pre-analysis pattern comprises preparing a sample and analyzing the sample, in which the pre-analysis pattern is disposed in the sample.

15. The method as claimed in claim 1, wherein analysis of the located pre-analysis pattern is accomplished by Scanning Electron Microscope (SEM), Transmission Electron Microscope (TEM) or Scanning Transmission Electron Microscope (STEM).

16. The method as claimed in claim 15, wherein analysis of the located pre-analysis pattern is accomplished by further using energy dispersive X-ray spectrometry (EDX), electron energy loss spectrometry (EELS) or Auger to analyze the surface characteristic, material or element.

17. The method as claimed in claim 1, wherein the pre-analysis pattern and the reference pattern are disposed in the same layer.

18. The method as claimed in claim 1, wherein the pre-analysis pattern and the reference pattern are disposed in different layers.
